(19) United States
(12) Patent Application Publication
(10) Pub. No.: US 2006/0268325 A1
(43) Pub. Date: Nov. 30, 2006

(54) Printer for directly printing PDF batch file and method thereof

(75) Inventor: Li Guang-Ming, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/374,013

(22) Filed: Mar. 14, 2006

(30) Foreign Application Priority Data
May 25, 2005 (KR) 2005-0044049

(51) Int. Cl. G06F 3/12

(52) U.S. Cl. 358/1.15; 358/1.13

(57) ABSTRACT

A printer having a PDF batch file direct print function and a method thereof are provided for preventing a printing error from occurring while printing the PDF batch file. The printer is connected to a predetermined terminal device and includes an interface unit receives PDF data from the terminal device, a detector detects a header mark identifying a header of the PDF data, a calculator calculates a distance between the header marks, if a plurality of header marks are detected by the detector, and a determination unit determines a data between the first and the second header marks as one PDF file, if a distance between a first header mark and a second head mark is greater than a certain threshold.

### CROSS-REFERENCED TO RELATED APPLICATIONS

This application claims the benefit under 35 U.S.C. § 119(a) of Korean Patent Application No 2005-44049, filed on May 25, 2005, in the Korean Intellectual Property Office, the entire disclosure of which is hereby incorporated by reference.

### BACKGROUND OF THE INVENTION

1. Field of the Invention

The present invention relates to a printer and a printing method thereof. More particularly, the present invention relates to a printer, which receives and directly prints a PDF batch file, and a printing method thereof.

2. Description of the Related Art

With the development of computer technology, peripherals for computers, such as, printers, scanners, photocopiers, facsimile machines, and multi-function peripherals are increasingly utilized. Recently developed printers are able to support a direct printing function with respect to a portable document format (PDF), tagged image file format (TIFF), and joint photographic experts group (JPEG) files.

The direct printing function refers to a function that directly performs printing simply by transmitting a file to a printer without executing an extra application at a host terminal, such as a personal computer (PC), lap-top computer, personal digital assistant (PDA), and digital camera. Since the printer including a direct printing function does not require a printer driver, user convenience can be greatly increased.

If a user batches a plurality of direct printing files into a single batch file and transmits the batch file to the printer, the user is enabled to print the plurality of direct printing files all at once by inputting a transmission command with respect to the batch file.

However, if PDF files are batched, all of the PDF files cannot be parsed due to their inherited characteristics. Accordingly, a problem may exist when some of the batched PDF files can not be printed.

Prior to the printing of a PDF file, the printer checks a header of the PDF file and identifies the PDF file version. Next, the printer checks a trailer of the PDF file and identifies the location of a cross-reference table. The cross-reference table contains information regarding the pages of the PDF file and location information regarding an object to be printed on each page. When printing the PDF file, the printer is required to identify the location of the object to print in the page according to the cross-reference table. Accordingly, if the location of the cross-reference table cannot be identified, the PDF file would not be printed. A trailer is typically placed at the end of the PDF file. However, if a garbage value is added to the PDF file, the garbage makes it difficult for the printer to detect the trailer at the end of the PDF file. In this instance, the printer parses data from the beginning to the end of the PDF file to detect the cross-reference table. When the parsing is performed up to the end of the PDF file, the cross-reference table is re-created. However, if a plurality of PDF files is batched into a single batch file, it is more difficult for the printer to perceive all the PDF files since an identifier is not provided to distinguish the PDF files. Therefore, the respective cross-reference tables of the PDF files cannot be detected. Thus, all the PDF files would not be printed.

Accordingly, there is a need for an improved printer and method for perceiving PDF files batched into a PDF file in order to prevent printing errors.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a printer which is capable of perceiving PDF files, if the PDF files are batched into a PDF batch file, by using a distance between header marks of each of the PDF files, and thereby preventing a printing error that occurs when directly printing the PDF batch file.

The above aspect of exemplary embodiments of the present invention is achieved by providing a printer connected to a predetermined terminal device, where an interface unit receives PDF data from the terminal device, a detector detects a header mark identifying a header of the PDF data, a calculator calculates a distance between header marks, if a plurality of header marks are detected by the detector, and a determination unit determines whether data between a first header mark and a second header mark comprises at least one PDF file, if a distance between the first header mark and the second header mark that are adjacent to each other is greater than a certain threshold.

In an exemplary implementation, the printer further includes a controller that evaluates a trailer of the PDF files determined by the determination unit and detects information regarding a cross-reference table, and a printing unit prints the PDF files according to the cross-reference table under the control of the controller.

In an exemplary implementation, if the distance between the first header mark and the second header mark is less than the threshold, the determination unit parses the data between the first and the second header marks and determines whether the data is garbage data.

In an exemplary implementation, if the data between the first and the second header marks is not garbage data, the controller creates a cross-reference table using a result of parsing.

The above aspect of exemplary embodiments of the present invention is achieved by providing a method for directly printing a PDF batch file of a printer which receives and prints a PDF batch file consisting of a plurality of PDF files, where PDF data is received, a header mark is detected identifying a header of the PDF data, a distance between the header marks is calculated, if a plurality of header marks are detected by the detector, and if a distance between a first header mark and a second header mark that are adjacent to each other is greater than a certain threshold, determining whether data between the first and the second header marks comprises at least one PDF file.

In an exemplary implementation, a trailer of the PDF files is evaluated and information regarding a cross-reference table is evaluated, and the PDF files are printed according to the cross-reference table.

In an exemplary implementation, if the distance between the first header mark and the second header mark is less than threshold, the data between the first and the second header marks are parsed, and a determination is made as to whether the data between the first and the second header marks is garbage data based on the parsing result.

In an exemplary implementation, if the data between the first and the second header marks is not garbage data, a cross-reference table is created using the parsing result.

In an exemplary implementation, a trailer of the PDF data is evaluated and a cross-reference table is detected; if the cross-reference table is detected, the PDF data is printed according to the cross-reference table; and if the cross-reference table is not detected, at least one header mark is detected and a determination is made as to whether data between a first header mark and a second header mark comprises at least one PDF file.

In an exemplary implementation, the header mark is % PDF and the threshold is 2 KB.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a block diagram illustrating a printer according to an exemplary embodiment of the present invention;

FIG. 2 is a view illustrating a configuration of a PDF batch file; and

FIG. 3 is a flowchart illustrating a printing method according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

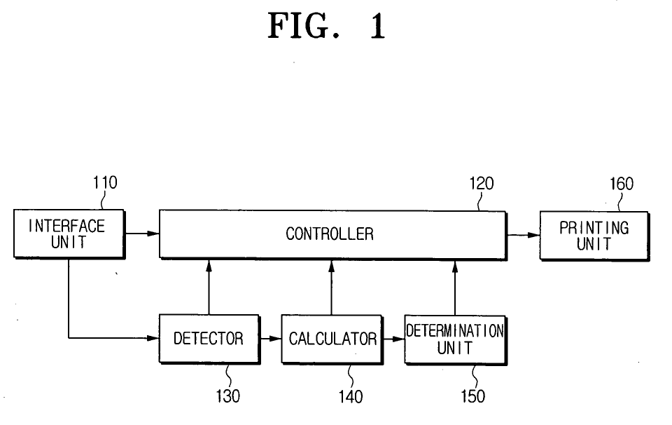

FIG. 1 is a block diagram illustrating a printer according to an exemplary embodiment of the present invention. Referring to FIG. 1, a printer comprises an interface unit 110, controller 120, detector 130, calculator 140, determination unit 150, and printing unit 160.

The interface unit 110 is connected to an external device, such as, a personal computer (PC), lap-top computer, and PDA, communicates with the external device and receives a certain portable document format (PDF) data. The interface unit 110 may comprise a parallel interface or universal serial bus (USB) interface.

The detector 130 checks a header and a trailer (that is, evaluates a header and a trailer) of the PDF filed received through the interface unit 110. The header identifies a version of the PDF file. For example, “% PDF-version number” represents the header. The header starts with a header mark “% PDF”. The detector 130 detects the header by referring to the header mark “% PDF”. The header is generally placed at the beginning of the PDF file.

The trailer identifies the location of a cross-reference table in the PDF file. For example, “% offset A” or “% prev B” represents the trailer, which identifies the cross-reference table as being located away from the beginning of the PDF file as much as A or as being located away from the trailer as much as B. If a normal PDF file is available, the trailer is placed at the end of the PDF file. Accordingly, the detector 130 checks the trailer from the end of the PDF file.

If the detector 130 detects the cross-reference table by normally checking the trailer (that is, evaluates the trailer), the controller 120 controls the printing unit 160 to print the PDF data. The printing unit 160 prints each of the PDF pages according to the cross-reference table.

If the PDF data is a single PDF batch file integrating a plurality of PDF files, the respective PDF files may not be distinguished from one another. Since the detector 130 detects only the end of the PDF data, the detector 130 does not detect all of the cross-reference tables of the PDF files. However, since the PDF files have respective header marks, the detector 120 detects a plurality of header marks, if the PDF batch file is input.

If the plurality of header marks is detected, the calculator 140 calculates a distance between the header marks. For example, the calculator 140 calculates a distance between a certain header mark and a previous header mark, and a distance between the certain header mark and a next header mark.

The determination 150 unit determines whether data between the header marks is a single PDF file. For example, the determination unit 150 compares a distance between a first header mark and a second header mark that are adjacent to each other with a certain threshold. If the distance between the first and the second header marks is greater than the threshold, the data between the first and the second header marks is determined as a single PDF file.

If the distance is less than the threshold, a determination is made as to whether the data between the first and the second header mark is garbage data. For example, the data between the first and the second header marks is parsed and a determination is made as to whether the data is comprehensible. If the data is not comprehensible, the data is determined as garbage data. If the minimum value in the size of general PDF file is set to the threshold, all of the data having a size less than the threshold is likely to be determined as the garbage data. However, since there is a possibility that a minute PDF file exists, data may be parsed. If the data is determined as garbage data, the controller 120 disregards or discards the data. Otherwise, the controller 120 re-creates the cross-reference table according to the result of parsing the data.

According to the above-described method, a number of PDF files that configure the PDF data is determined based on the total head marks detected. The controller 120 checks trailers of the PDF files using the detector 130 and detects the cross-reference tables of the PDF files. The controller 120 controls the printing unit 160 to print the PDF files respectively according to the detected cross-reference tables.

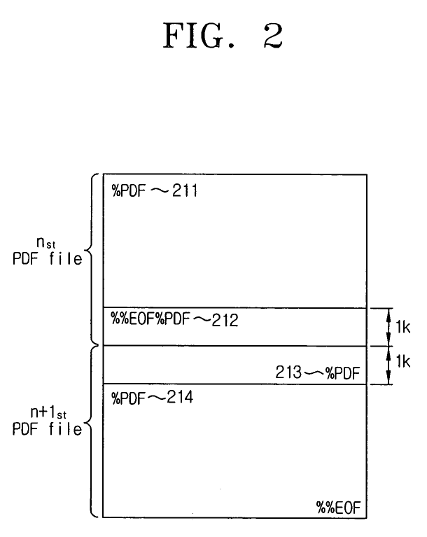

FIG. 2 is a view illustrating a configuration of the PDF batch file to explain an operation of the printer according to an exemplary embodiment of the present invention. As shown in FIG. 2, the PDF batch file consists of a plurality of PDF files. The n-th PDF file includes two marks “% PDF” 211, 212, and two marks “% PDF” are detected by the detector 130. The calculator 140 calculates a distance between the marks “% PDF” 211, 212. The determination unit 150 compares the calculated distance with a threshold. The threshold is set in consideration of the characteristics of the PDF file. According to the PDF standard, garbage data of 1 KB may be added to each of the PDF files. For example, as shown in FIG. 2, the garbage data of 1 KB is added to the end of the n-th PDF file and garbage data of 1 KB is added to the beginning of the n+1-th PDF file. In an exemplary implementation, the garbage data has a maximum length. Accordingly, the threshold may be set to 2 KB. If the distance calculated by the calculator 140 is greater than 2 KB, the data between the two marks “% PDF” is not determined as the garbage data and recognized as a single PDF file. Since the data between the first “% PDF” 211 and the second “% PDF” 212 of FIG. 2 is greater than 2 KB, the data is recognized as a single PDF file.

A distance between the second and the third marks “% PDF” 212, 213, and a distance between the third and the fourth marks “% PDF” 213, 214 are less than 2 KB. In an exemplary implementation, the data between the second and third marks “% PDF”, and the third and fourth marks “% PDF” may be determined as garbage data, but the data may be a minute PDF file. Also, since the data is less than 2 KB, a small amount of time may be taken to parse the data. That is, if the data between two marks “% PDF” is less than the threshold, the data is parsed and then is determined to be the garbage data. Accordingly, the data between the second mark “% PDF” 212 and the third mark “% PDF” 213, and the data between the third mark “% PDF” 213 and the fourth mark “% PDF” 214 are recognized as garbage data, respectively. In an exemplary implementation as described above, a determination as to whether the data between the header marks is one independent PDF file or garbage data is performed with respect to the total PDF files.

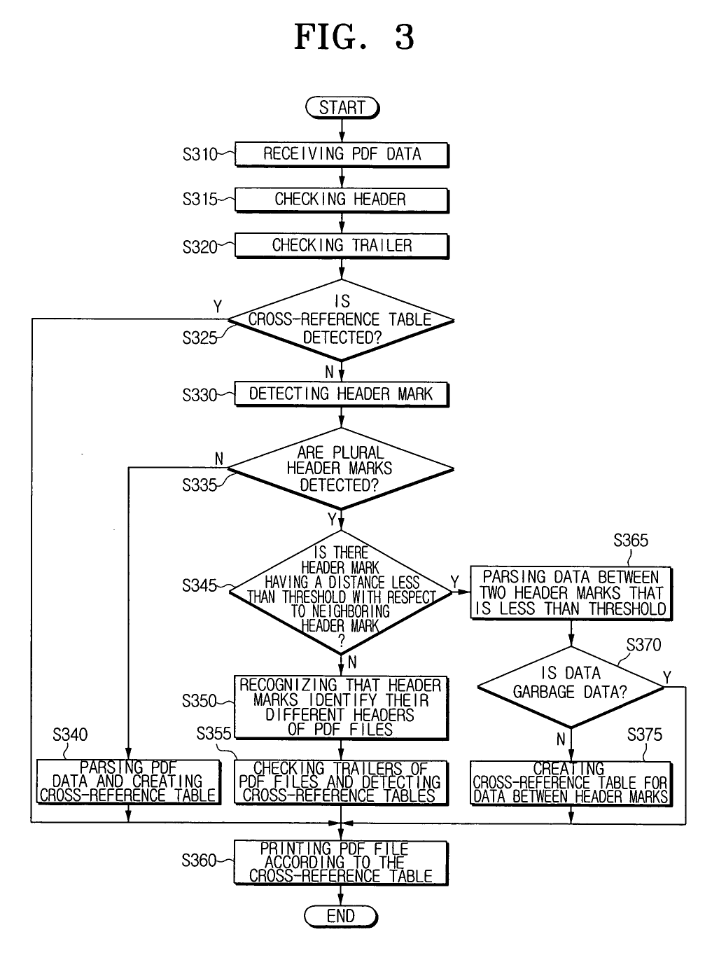

FIG. 3 is a flowchart illustrating a method for directly printing a PDF batch file according to an exemplary embodiment of the present invention. Referring to FIG. 3, if PDF data is received at operation S310, the header of the PDF file is checked and a version is identified at operation S315. Then, the trailer is checked and the cross-reference table is identified at operation S320. If the PDF data is a single PDF file, the cross-reference table is normally detected by referring to the trailer. However, if the PDF data is a PDF batch file, the PDF files would not be distinguished from one another. Thus, the trailer of the last PDF file is checked. In an exemplary implementation, the cross-reference table cannot be normally detected. Accordingly, after checking the trailer, a determination is made as to whether the cross-reference table is normally detected at operation S325. If the cross-reference table is normally detected, the printer prints the PDF data according to the cross-reference table at operation S360.

If the cross-reference table is not detected, the header mark is detected at operation S330, and then a determination is made as to whether a plurality of header marks exists at operation S335. Accordingly, the mark “% PDF” represents the header mark.

If a plurality of header marks is not detected, the cross-reference tables are detected by parsing the total PDF files. Thus, a cross-reference table is re-created, at operation S340.

If a plurality of header marks is detected, a distance between neighboring header marks is calculated. A determination is made as to whether a header mark having a distance less than a threshold with respect to its neighboring header mark exists at operation S345.

If a determination is made that two header marks having a distance less than the threshold therebetween (first and second header marks) exists, the data between the first and the second header marks is parsed at operation S365. Also, a determination is made as to whether the data is a garbage data at operation S370. If the data between the first and the second header marks is incomprehensible or meaningless, the data is determined to be the garbage data.

On the other hand, if the data between the first and the second header marks is garbage data, the data is disregarded, and a determination is made as to whether a distance between another header mark is less than the threshold. If the data is not garbage data, a cross-reference table is created in accordance with the data between the first and the second header marks at operation S375. In an exemplary implementation, since the data has been already parsed, the cross reference table is directly created as the result of parsing.

If the distances between the header marks are greater than the threshold, recognition is made that the header marks identify their respective different PDF files at operation S350. That is, a determination is made that the PDF files start with their header marks. Accordingly, the trailers are checked by detecting upper points of the header marks and cross-reference tables are detected according to information recorded to the trailers at operation S355. The PDF files are respectively printed according to the cross-reference tables at operation S360. As described above, the PDF files of the PDF batch file are distinguished from one another and are printed.

As described above, when a PDF batch file is received, the printer distinguishes the PDF files using the header marks. Thus, a printing error is prevented. Since parsing the entire PDF batch file is not necessary to detect the cross-reference table, a control load of the printer can be reduced and time necessary to print can be reduced. Also, if the distance between the header marks is less than the threshold, a determination is made as to whether the data between the header marks is garbage data. Accordingly, detecting a minute PDF file is possible.

While the invention has been shown and described with reference to certain exemplary embodiments thereof, it will be understood by those skilled in the art that various changes in form and details may be made therein without departing from the spirit and scope of the invention as defined by the appended claim.

What is claimed is:

1. A printer connected to a terminal device, comprising:
an interface unit for receiving PDF data from the terminal device;
a detector for detecting at least one header mark identifying a header of the PDF data;
a calculator for calculating a distance between header marks, if a plurality of header marks are detected by the detector; and
a determination unit for determining whether data between a first header mark and a second header mark, adjacently located, comprises at least one PDF file, if the distance between the first header mark and the second header mark is greater than a reference threshold.

2. The printer as claimed in claim 1, further comprising:
a controller for evaluating a trailer of the at least one determined PDF file and detecting information regarding a cross-reference table; and
a printing unit for printing the at least one PDF file according to the cross-reference table controlled by the controller.

3. The printer as claimed in claim 2, wherein, if the distance between the first header mark and the second header mark is less than the reference threshold, the determination unit parses the data between the first header mark and the second header mark and determines whether the data comprises garbage data.

4. The printer as claimed in claim 3, wherein, if the data between the first header mark and the second header mark does not comprise the garbage data, the controller creates a cross-reference table using the parsing result.

5. The printer as claimed in claim 1, wherein the header mark comprises % PDF.

6. The printer as claimed in claim 1, wherein the threshold comprises 2 KB.

7. A method for directly printing a PDF batch file of a printer, the method comprising:
receiving a PDF data;
detecting at least one header mark identifying a header of the PDF data;
calculating a distance between header marks, if a plurality of header marks are detected; and
determining whether data between a first header mark and a second header mark, adjacently located, comprises at least one PDF file, if the distance between the first header mark and the second header mark is greater than a reference threshold.

8. The method as claimed in claim 7, further comprising:
evaluating a trailer of the at least one PDF file determined and detecting information regarding a cross-reference table; and
printing the at least one PDF file according to the cross-reference table.

9. The method as claimed in claim 7, further comprising:
parsing the data between the first header mark and the second header mark, if the distance between the first header mark and the second header mark is less than the reference threshold; and
determining whether the data between the first header mark and the second header mark comprises garbage data based on the parsing result.

10. The method as claimed in claim 9, further comprising creating a cross-reference table using the parsing result, if the data between the first header mark and the second header mark does not comprise the garbage data.

11. The method as claimed in claim 7, further comprising:
evaluating a trailer of the PDF data and detecting a cross-reference table;
printing the PDF data according to the cross-reference table, if the cross-reference table is detected; and
detecting at least one header mark and determining whether data between a first header mark and a second header mark comprises at least one PDF file, if the cross-reference table is not detected.

12. The method as claimed in claim 7, wherein the header mark comprises % PDF.

13. The method as claimed in claim 7, wherein the reference threshold comprises 2 KB.
